(19) United States
(12) Patent Application Publication
(10) Pub. No.: US 2025/0326959 A1
(43) Pub. Date: Oct. 23, 2025

(54) TWO-COMPONENT LOW-DENSITY PU STRUCTURAL ADHESIVE, PREPARATION METHOD THEREFOR AND APPLICATION THEREOF

(71) Applicant: Jiangsu Changneng Energy-saving New Materials Science & Technology Co., LTD., Jiangsu (CN)

(72) Inventors: Yu Ding, Jiangsu (CN); Wenjie Cao, Jiangsu (CN)

(73) Assignee: Jiangsu Changneng Energy-saving New Materials Science & Technology Co., LTD., Jiangsu (CN)

(21) Appl. No.: 18/826,153

(22) Filed: Sep. 5, 2024

(30) Foreign Application Priority Data
Apr. 22, 2024 (CN) 202410481962.7

(51) Int. Cl. C09J 175/08; C08G 18/10; C08G 18/32; C08G 18/36; C08G 18/40; C08G 18/44; C08G 18/48; C08G 18/66; C08K 3/34; C08K 5/54; C08K 7/26; C08K 7/28; C08K 13/04; C09J 11/04

(52) U.S. Cl. CPC C09J 175/08; C08G 18/10; C08G 18/3206; C08G 18/36; C08G 18/4018; C08G 18/44; C08G 18/4895; C08G 18/6696; C08K 13/04; C09J 11/04; C08K 2003/343; C08K 5/54; C08K 7/26; C08K 7/28

(57) ABSTRACT

Disclosed are a two-component low-density PU structural adhesive, a preparation method therefor and an application thereof. The two-component low-density PU structural adhesive is composed of Component A and Component B, where a volume ratio of Component A to Component B is 1:0.8-1.2, Component A includes polyether carbonate polyol, castor oil or/and modified castor oil, bisphenol A polyether polyol, a chain extender, hollow glass beads, molecular sieve, fumed silica, a silane coupling agent and catalysts, specifically, the polyether carbonate polyol and the castor oil or/and the modified castor oil cannot be zero at the same time; and Component B includes isocyanate prepolymer, polyisocyanate, hollow glass beads, fumed silica, and a dehydrating agent, the present disclosure solves the problems of poor storage stability, low bonding strength and low elongation at break of the low-density structural adhesive in the prior art.

### CROSS-REFERENCE TO RELATED APPLICATION

This application claims the priority benefit of China application serial no. 202410481962.7, filed on Apr. 22, 2024. The entirety of the above-mentioned patent application is hereby incorporated by reference herein and made a part of this specification.

### BACKGROUND

### Technical Field

The present disclosure relates to the field of adhesives, and particularly relates to a two-component low-density PU structural adhesive, a preparation method therefor and an application thereof.

### Description of Related Art

During rapid development of new energy vehicles, range anxiety has always been a prevalent issue. Given no technical innovations in power batteries of passenger cars, lightweighting remains an effective way to improve ranges of the vehicles. In order to reduce a mass of a battery pack during installation of a power battery, a structural adhesive is often used to fix a battery cell, so as to replace some of metal components thereof to reduce the mass of the battery pack. Densities of conventional two-component PU structural adhesives used for battery cell bonding are generally greater than 1.3 g/ml. A low-density structural adhesive prepared in the present disclosure has a density of 0.8 g/ml. Compared with the conventional structural adhesives, a mass of the low-density structural adhesive in the present disclosure is reduced by approximately 40% while maintaining other performance properties.

The existing low-density structural adhesives mostly use low-density hollow glass beads to reduce density. However, using the hollow glass beads often has the following problems. First, the storage stability of a curing agent component containing isocyanate may be problematic due to high moisture content and strong alkalinity of the hollow glass beads; second, large particle sizes of the hollow glass beads can lead to a decrease in tensile shear strength and elongation at break of a cured adhesive as an adding amount of the hollow glass beads increases, resulting in a deteriorating elasticity of the cured adhesive.

The Chinese Patent (Application No.: CN202211025040.2) disclosed a PU structural adhesive that includes the following raw materials by mass percentage: 9.3-26% of modified castor oil, 6-24.3% of isocyanate, and 2.6-10% of polyether polyol; the isocyanate includes a first isocyanate monomer, a second isocyanate monomer, and polymeric methylene diphenyl diisocyanate (polymeric MDI); the first isocyanate monomer includes an aromatic isocyanate monomer; the second isocyanate monomer includes at least one of an aliphatic isocyanate monomer and an alicyclic isocyanate monomer. A density of the low-density structural adhesive prepared in the patent is only about 1.05 g/ml, which is only a reduction of less than 20% compared with the density of the conventional structural adhesives, indicating that the density reduction is not significant enough.

The Chinese Patent (Application No. CN202310282905.1) disclosed a preparation method for a two-component lightweight PU structural adhesive, which includes a first component and a second component, where a volume ratio of the first component to the second component is 0.8:1-1.2:1; the first component specifically includes the following components by mass fraction: 80-95 wt % of polyol, 0.02-1 wt % of a catalyst, 0.02-1 wt % of color paste, 3-6 wt % of molecular sieve, 0.5-3 wt % of fumed silica, and 5-10 wt % of a first filler; and the second component specifically includes the following components by mass fraction: 45-55 wt % of an isocyanate prepolymer, 3-6 wt % of a plasticizer, 0.5-3 wt % of fumed silica, 45-55 wt % of a second filler, and 0.5-1 wt % of an auxiliary agent. Although the patent improves the storage stability of the second component by adding an organic acid, the addition of the organic acid slows down a reaction rate after the first component and the second component are mixed, thereby resulting in insufficient curing at room temperature, such that the adhesive cannot meet performance requirements. In addition, in order to reduce viscosity, the plasticizer is added in the second component, which will lead to lots of environmental issues.

### SUMMARY

A first technical problem to be solved by the present disclosure is poor storage stability, low bonding strength and low elongation at break of two-component low-density polyurethane structural adhesives in the prior art, therefore, the present disclosure provides a novel two-component low-density PU structural adhesive, which has the advantages of good storage stability, high bonding strength and high elongation at break.

A second technical problem to be solved by the present disclosure is to provide a preparation method for the two-component low-density PU structural adhesive described in the first technical problem.

A third technical problem to be solved by the present disclosure is to provide application of the two-component low-density PU structural adhesive described in the second technical problem.

In order to solve the first technical problem, the present disclosure adopts the following technical solution: a two-component low-density PU structural adhesive, which is composed of Component A and Component B, where A volume ratio of Component A to Component B is 1:0.8-1.2, Component A includes 0-70 parts by weight of polyether carbonate polyol, 0-50 parts by weight of castor oil or/and modified castor oil, 0-30 parts by weight of bisphenol A polyether polyol, 5-20 parts by weight of a chain extender, 5-25 parts by weight of hollow glass beads, 1-10 parts by weight of molecular sieve, 1-5 parts by weight of fumed silica, 0.1-1 part by weight of a silane coupling agent and 0.01-0.15 part by weight of catalyst, specifically, the polyether carbonate polyol and the castor oil or/and the modified castor oil cannot be zero at the same time; Component B includes 40-75 parts by weight of isocyanate prepolymer, 5-35 parts by weight of polyisocyanate, 5-25 parts by weight of hollow glass beads, 0.5-5 parts by weight of fumed silica, and 0.1-1 part by weight of a dehydrating agent, and the isocyanate prepolymer is prepared by reacting polyether carbonate polyol and polyisocyanate at a mass ratio of 1:0.5-1.5.

In the above technical solution, preferably, the polyether carbonate polyol in Component A is 30-70 parts.

In the above technical solution, preferably, the castor oil in Component A is 20-50 parts.

In the above technical solution, preferably, the polyether carbonate polyol has a functionality of 2-4, a number-average molecular weight of 400-5000, and a mass percentage content of CO₂ of 5-35%; the castor oil is first-grade castor oil, and the modified castor oil is selected from at least one of A4100, A4110, or A4120; and the bisphenol A polyether polyol is selected from BPA3PO.

In the above technical solution, preferably, the chain extender is selected from at least one of glycerol, diethylene glycol, dipropylene glycol or 1,5-pentanediol; the hollow glass beads are selected from at least one of HS28 or S28HS; the molecular sieve is selected from at least one of JLH-03-B or JZ-AZ3; and the fumed silica is selected from at least one of AEROSIL R202, TS-720 or KS-150.

In the above technical solution, preferably, the silane coupling agent is selected from at least one of KH-560, KH-570 or CG-1146; the catalyst is selected from at least one of dibutyltin dilaurate, bismuth neodecanoate or triethylene diamine; and the dehydrating agent is selected from at least one of oxazolidine ALT-201 or Additive TI.

In the above technical solution, preferably, NCO content of the isocyanate prepolymer is 10-20%.

In the above technical solution, preferably, the polyisocyanate is selected from at least one of liquefied MDI LL, MDI-50, M20S trimer, or PM-200.

In order to solve the second technical problem, the present disclosure provides a preparation method for the two-component low-density PU structural adhesive, including the following steps:
(1) preparation of Component A: at room temperature, adding 0-70 parts by weight of polyether carbonate polyol, 0-50 parts by weight of castor oil or/and modified castor oil, 0-30 parts by weight of bisphenol A polyether polyol, 5-20 parts by weight of a chain extender, 5-25 parts by weight of hollow glass beads, 1-10 parts by weight of molecular sieve, 1-5 parts by weight of fumed silica, 0.1-1 part by weight of a silane coupling agent and 0.01-0.15 part by weight of catalyst into a container A, where the polyether carbonate polyol and the castor oil or/and the modified castor oil cannot be zero at the same time; and stirring the components evenly obtain Component A;
preparation of Component B: adding 40-75 parts by weight of isocyanate prepolymer, 5-parts by weight of the polyisocyanate, 5-25 parts by weight of hollow glass beads, 0.5-5 parts by weight of fumed silica and 0.1-1 part by weight of dehydrating agent into a container B and mixed evenly to obtain Component B; where the isocyanate prepolymer is prepared by reacting polyether carbonate polyol and polyisocyanate at a mass ratio of 1:0.5-1.5; and
(3) mixing Component A and Component B evenly at a volume ratio of 1:0.8-1.2 to obtain the two-component low-density PU structural adhesive.

In the above technical solution, preferably, a preparation method for the isocyanate prepolymer is as follows: adding the polyether carbonate polyol into a reaction kettle, heating the same to 110-130° C. for vacuum dehydration for 1-2 h, cooling down to room temperature, adding the polyisocyanate and reacting at 70-90° C. for 2-3 h to obtain the isocyanate prepolymer, where a mass ratio of the polyether carbonate polyol to the polyisocyanate is 1:0.5-1.5.

In order to solve the third technical problem, the present disclosure adopts the following technical solution: an application of the two-component low-density PU structural adhesive in structural bonding of a battery pack for a new energy vehicle.

The present disclosure provides a two-component low-density PU structural adhesive. By adjusting the content of the hollow glass beads in Component A and Component B, the content of the hollow glass beads in Component B is reduced as much as possible, the alkalinity of Component B is reduced, the possibility of self-polymerization of the NCO groups in Component B is weakened under the condition that a final mixing density is low, such that the storage stability of Component B is improved; more fumed silica is added to adjust the viscosity of the system, such that the storage stability of the entire system the storage stability of the whole system is improved; polyether carbonate polyol having carbonate bonds with greater polarity and bisphenol A polyether polyol structure with a great number of benzene rings are introduced to improve interaction between the polymer and the substrate, and the bonding performance of the adhesive is thus improved; and ether bonds with better flexibility a molecular structure of the polycarbonate polyol enables the elongation at break of the polymer to be relatively high, thereby achieving better technical effects.

### DESCRIPTION OF THE EMBODIMENTS

The present disclosure will be further described below with reference to the embodiments, and it is necessary to note that the following embodiments are merely illustrative of the present disclosure and cannot be understood as a limitation to the scope of protection of the present disclosure. Those skilled in the art may make some non-essential improvements and adjustments according to the contents of the present disclosure, which all fall within the scope of protection of the present disclosure.

TABLE 1
List of raw materials

| Type of raw | Brand and | | |
|---|---|---|---|
| material | specifications | Manufacturer | Others |
| Polyether | PCE-1 | Self-made | Hydroxyl value 53 |
| carbonate polyol | | | mgKOH/g, CO₂ = 15% |
| | PCE-2 | Self-made | Functionality 3, hydroxyl |
| | | | value 57 mgKOH/g, |
| | | | CO₂ = 9.4% |
| Castor oil | First-grade | Guangzhou Liaotong | Functionality 2.7, hydroxyl |
| | castor oil | Chemical Co., Ltd. | value 165 mgKOH/g |
| Modified castor | A4120 | Shanghai Joule New | Functionality 2, hydroxyl |
| oil | | Material Tech. Co., Ltd. | value 224 mgKOH/g |
| Bisphenol A | BPA-3PO | Zhejiang Huangma New | Functionality 2, hydroxyl |
| polyether polyol | | Material Co., Ltd. | value 280 mgKOH/g |
| Polyether polyol | EP-330N | Shandong Bluestar | Functionality 3, hydroxyl |
| | | Dongda Co., Ltd. | value 35 mgKOH/g |
| Chain extender | Dipropylene | Aladdin Reagent | |
| | glycol | | |
| | Glycerol | (Shanghai) Co., Ltd. | |
| Hollow glass | HS-28 | Zhengzhou Hollowlite | |
| beads | | Materials Co., Ltd. | |
| | S28HS | 3M Company | |
| | GS-32 | Sinosteel Maanshan | |
| | | General Institute of | |
| | | Mining Research Co., | |
| | | Ltd. | |
| Molecular sieve | JZ-AZ3 | Shanghai Jiuzhou | 3A molecular sieve |
| | | Chemicals Co., Ltd. | |
| | JLH-03-B | Luoyang Jalon Micro- | 3A molecular sieve |
| | | nano New Materials Co., | |
| | | Ltd. | |
| Fumed silica | KS-150 | Anhui Zaisheng New | |
| | | Material | |
| Silane coupling | KH-560 | Nanjing Quanxi | |
| agent | | Chemical Co., Ltd. | |
| Catalyst | A-33 | Newtop Chemical | |
| | | Materials (Shanghai) Co., | |
| | | Ltd. | |
| Dehydrating agent | Additive TI | Borchers | |
| Polyisocyanate | MDI LL | Kumho Mitsui Chemicals | |
| Isocyanate | PP-1 | Self-made | NCO % = 13.4% |
| prepolymer | PP-2 | Self-made | NCO % = 12.55% |

In Table 1, the polyether carbonate polyols PCE-1 and PCE-2 are self-made in a laboratory, and a preparation method therefor can refer to a method stated in the Chinese patent CN 110922577 B.

### Preparation of the Isocyanate Prepolymer:

PP-1: An isocyanate prepolymer PP-1 is prepared by reacting MDI LL and dehydrated polyether polyol EP-330N at a weight ratio of 1:1 at 80° C. for 2 h.

PP-2: An isocyanate prepolymer PP-2 is prepared by reacting MDI LL and dehydrated polyether carbonate polyol PCE-2 at a weight ratio of 1:1 at 80° C. for 2 h.

### Example 1

A preparation method for a two-component low-density PU structural adhesive, including the following steps:
(1) preparation of Component A: 32.99 parts by weight of the polyether carbonate polyol, 24 parts by weight of the first-grade castor oil, 5 parts by weight of the bisphenol A polyether polyol (BPA3PO), 10 parts by weight of the dipropylene glycol, 2 parts by weight of the glycerol, 14 parts by weight of the hollow glass beads (S28HS), 8 parts by weight of the molecular sieve (JZ-AZ3), 3.5 parts by weight of the fumed silica (KS-150), 0.5 part by weight of the silane coupling agent (KH-560), and 0.01 part by weight of the catalyst (A-33) were added into a container A and mixed evenly to obtain Component A;
(2) preparation of Component B: 57.2 parts by weight of the isocyanate prepolymer PP-2, 26 parts by weight of the polyisocyanate (MDI LL), 13 parts by weight of the hollow glass beads (S28HS), 3.5 parts by weight of the fumed silica (KS-150) and 0.3 part by weight of the dehydrating agent were added into a container B and mixed evenly to obtain Component B; and
(3) when in use, Component A and Component B were mixed evenly at a volume ratio of 1:1 to obtain the two-component low-density PU structural adhesive, and performance detection results of the obtained two-component low-density PU structural adhesive were shown in Table 3.

### Examples 2-12

Steps of Examples 2-12 were the same as those of Example 1, except that reaction raw materials and ratios thereof were different, as shown in Table 2; and performance detection results of the prepared two-component low-density PU structural adhesives were shown in Table 3.

### Comparative Examples 1-3

Steps of Comparative Examples 1-3 were the same as those of Example 1, except that reaction raw materials and ratios thereof were different, as shown in Table 2; and performance detection results of the prepared two-component PU structural adhesive were shown in Table 3.

TABLE 2
Raw material components of two-component low-density PU structural
adhesives prepared in Examples 1-12 and Comparative Examples 1-3

| Name of raw | Example | Example | Example | Example | Example | Example |
|---|---|---|---|---|---|---|
| material | 1 | 2 | 3 | 4 | 5 | 6 |

Component A:

| | | | | | | |
|---|---|---|---|---|---|---|
| PCE-1 | 33 | 45 | | 65.9 | 40.95 | |
| PCE-2 | | | | | | |
| First-grade castor | 24 | | 49 | | | |
| oil | | | | | | |
| EP-330N | | | | | | |
| A4120 | | | | | 24 | 48 |
| BPA3PO | 5 | 16 | 21 | | | 21 |
| Dipropylene glycol | 11 | 13 | 6 | 10 | 9 | 6 |
| Glycerol | 1 | 0.5 | 1.2 | 2.5 | 2 | |
| JZ-AZ3 | 8 | 8 | 6 | | | |
| JLH-03-B | | | | 5 | 7 | 8 |
| KS150 | 3.19 | 3.17 | 3 | 2.73 | 2.7 | 2.65 |
| HS-28 | | | | 13.5 | 14 | |
| S28HS | 14.3 | 13.8 | 13.3 | | | 14 |
| GS-32 | | | | | | |
| KH-560 | 0.5 | 0.5 | 0.45 | 0.3 | 0.3 | 0.3 |
| A-33 | 0.01 | 0.03 | 0.05 | 0.07 | 0.05 | 0.05 |
| Total | 100 | 100 | 100 | 100 | 100 | 100 |

Component B

| | | | | | | |
|---|---|---|---|---|---|---|
| PP-1 | | | 53.9 | | | 52.9 |
| PP-2 | 57.2 | 56.3 | | 62 | 55 | |
| MDILL | 26.5 | 28.5 | 30.5 | 21.15 | 28.95 | 32 |
| HS-28 | | | | 14 | 13 | |
| S28HS | 13 | 12 | 12 | | | 12 |
| GS-32 | | | | | | |
| KS-150 | 3 | 3 | 3.45 | 2.7 | 2.9 | 2.95 |
| Additive TI | 0.3 | 0.2 | 0.15 | 0.15 | 0.15 | 0.15 |
| Total | 100 | 100 | 100 | 100 | 100 | 100 |
| A:B (Volume | 1:1 | 1:1 | 1:1 | 1:1 | 1:1 | 1:1 |
| ratio) | | | | | | |

| | | | | | | | | | |
|---|---|---|---|---|---|---|---|---|---|
| Name of | | | | | | | | | |
| raw | Example | Example | Example | Example | Example | Example | Comparative | Comparative | Comparative |
| material | 7 | 8 | 9 | 10 | 11 | 12 | Example 1 | Example 2 | Example 3 |

Component A:

| | | | | | | | | | |
|---|---|---|---|---|---|---|---|---|---|
| PCE-1 | | | | | | | | | |
| PCE-2 | 32.99 | 32.47 | 35.35 | 43.43 | 29.95 | 26.45 | 33.35 | | |
| First-grade | 24 | 20 | 12 | 5 | | | 12 | 34.17 | |
| castor oil | | | | | | | | | |
| EP-330N | | | | | | | | 24 | 37.47 |
| A4120 | | | | | 14 | 20 | | | |
| BPA3PO | 5 | 10 | 16 | 20 | 20 | 19 | 16 | | 25 |
| Dipropylene | 10 | 11 | 13 | 10 | 9 | 8 | 13 | 12.5 | 9 |
| glycol | | | | | | | | | |
| Glycerol | 2 | 1.5 | 1.2 | | 2 | 1.5 | 1.2 | 3 | 2.5 |
| JZ-AZ3 | 8 | 8 | 6 | | | | 6 | 8 | 8.5 |
| JLH-03-B | | | | 5 | 7 | 8 | | | |
| KS150 | 3.5 | 3.5 | 3 | 2.7 | 2.7 | 2.7 | 3 | 3.5 | 3 |
| HS-28 | | | | 13.5 | 15 | | | | |
| S28HS | 14 | 13 | 13 | | | 14 | | 14 | 14 |
| GS-32 | | | | | | | 15 | | |
| KH-560 | 0.5 | 0.5 | 0.4 | 0.3 | 0.3 | 0.3 | 0.4 | 0.5 | 0.5 |
| A-33 | 0.01 | 0.03 | 0.05 | 0.07 | 0.05 | 0.05 | 0.05 | 0.03 | 0.03 |
| Total | 100 | 100 | 100 | 100 | 100 | 100 | 100 | 100 | 100 |

Component B:

| | | | | | | | | | |
|---|---|---|---|---|---|---|---|---|---|
| PP-1 | | | | | | | | 55.35 | 59.3 |
| PP-2 | 57.2 | 56.3 | 53.85 | 62 | 55 | 52.95 | 53 | | |
| MDI LL | 26 | 28.5 | 32.5 | 21.15 | 30.95 | 32 | 32.3 | 30 | 26 |
| HS-28 | | | | 14 | 11 | | | | |
| S28HS | 13 | 12 | 11 | | | 12 | | 12 | |
| GS-32 | | | | | | | 12 | | |
| KS-150 | 3.5 | 3 | 2.5 | 2.7 | 2.9 | 2.9 | 2.5 | 2.5 | 2.5 |
| Additive TI | 0.3 | 0.2 | 0.15 | 0.15 | 0.15 | 0.15 | 0.2 | 0.15 | 0.15 |
| Total | 100 | 100 | 100 | 100 | 100 | 100 | 100 | 100 | 100 |
| A:B | 1:1 | 1:1 | 1:1 | 1:1 | 1:1 | 1:1 | 1:1 | 1:1 | 1:1 |
| (Volume | | | | | | | | | |
| ratio) | | | | | | | | | |

TABLE 3
Performance data of two-component low-density PU structural adhesives
prepared in Examples 1-12 and Comparative Examples 1-3

| | Items tested | | | | |
|---|---|---|---|---|---|
| | | | | | Storage |
| | Tensile | Elongation | Tensile shear | | stability of |
| | strength | at break | strength | Density | Component B |
| | Unit | | | | |
| | MPa | % | MPa | g/ml | d |
| | Detection standards | | | | |
| | GB/T 1040.1-2018 | | GB/T 7124-2008 | GB/T 13354 | GB 6753.3-86 |
| Example 1 | 14.92 | 61.51 | 12.65 | 0.78 | 40 |
| Example 2 | 14.27 | 69.93 | 12.04 | 0.82 | 40 |
| Example 3 | 11.85 | 70.24 | 10.21 | 0.80 | 40 |
| Example 4 | 14.97 | 60.12 | 12.88 | 0.78 | 40 |
| Example 5 | 14.86 | 62.35 | 12.47 | 0.81 | 40 |
| Example 6 | 12.32 | 69.01 | 10.40 | 0.82 | 40 |
| Example 7 | 14.75 | 64.28 | 12.42 | 0.79 | 40 |
| Example 8 | 13.81 | 74.64 | 11.59 | 0.82 | 40 |
| Example 9 | 12.93 | 66.5 | 10.89 | 0.81 | 40 |
| Example 10 | 10.87 | 82.4 | 10.28 | 0.78 | 40 |
| Example 11 | 13.70 | 62.94 | 12.31 | 0.78 | 40 |
| Example 12 | 13.58 | 72.83 | 12.59 | 0.82 | 40 |
| Comparative | 10.75 | 28.75 | 7.42 | 0.89 | 5 |
| Example 1 | | | | | |
| Comparative | 9.24 | 94.13 | 5.45 | 0.81 | 40 |
| Example 2 | | | | | |
| Comparative | 8.64 | 140.5 | 4.58 | 0.81 | 40 |
| Example 3 | | | | | |

Before the test, samples were all cured for 7 d in a standard environment of 25±2° C. and 50% RH, and mechanical properties thereof were tested according to the requirements of a national standard GB/T 1040.1-2018. To test bonding strengths, the two-component PU structural adhesives were respectively coated and applied on 3003 aluminum sheets, the 3003 aluminum sheets were overlapped and pressed, and tests of tensile shear strengths were then performed according to a test method stated in a national standard GB/T 7124-2008. Densities thereof were tested according to the provisions of GB/T 13354, stabilities thereof were tested according to the provisions of GB 6753.3-86 by being filled with Component B and placed in an oven of 50° C. for accelerated testing for 40 d.

It could be seen from the data of Examples 1-12 and Comparative Example 1 that the densities of the structural adhesive prepared in Examples 1-12 were significantly lower than that of Comparative Example 1, this was mainly because the hollow glass beads in Comparative Example 1 could break during a dispersion process, resulting in a density of the prepared structural adhesive greatly higher than a theoretical value; storage stabilities of the prepared structural adhesives in Examples 1-12 were better than that of in Comparative Example 1, because: the hollow glass beads contained in Component B in Examples 1-12 were less, alkalinities of the systems thereof were weaker, and the possibility of self-polymerization of the isocyanate was accordingly smaller, and at the same time, in order to prevent the hollow glass beads with lighter mass from floating up, more fumed silica was added therein to adjust viscosities of the systems, such that the storage stabilities of the whole systems thereof were improved.

Compared with the two-component low-density PU structural adhesives prepared in Comparative Examples 1-3, those prepared in Examples 1-12 exhibit better bonding performance, this is because carbonate bonds with greater polarity and ether bonds with better flexibility contained in the polyether carbonate polyol added in Examples 1-12 have beneficial effects, and furthermore, the bisphenol A polyether polyol structure introduced therein contains a large number of benzene rings, which can also increase the interaction between a resin and a substrate, and the bonding performance is thus further improved. The two-component low-density PU structural adhesive prepared by the present disclosure has the advantages of low density, good storage stability, excellent bonding performance and high elongation at break, achieves better technical effects, and can be used in structural bonding of battery packs for new energy vehicles.

What is claimed is:

1. A two-component low-density PU structural adhesive, being composed of Component A and Component B, wherein a volume ratio of Component A to Component B is 1:0.8-1.2, Component A comprises 0-70 parts by weight of polyether carbonate polyol, 0-50 parts by weight of castor oil or/and modified castor oil, 0-30 parts by weight of bisphenol A polyether polyol, 5-parts by weight of a chain extender, 5-25 parts by weight of hollow glass beads, 1-10 parts by weight of molecular sieve, 1-5 parts by weight of fumed silica, and 0.1-1 part by weight of a silane coupling agent and 0.01-0.15 part by weight of a catalyst; the polyether carbonate polyol and the castor oil or/and the modified castor oil cannot be zero at the same time; Component B comprises 40-75 parts by weight of isocyanate prepolymer, 5-35 parts by weight of polyisocyanate, 5-25 parts by weight of hollow glass beads, 0.5-5 parts by weight of fumed silica, and 0.1-1 part by weight of a dehydrating agent, and the isocyanate prepolymer is prepared by reacting polyether carbonate polyol and polyisocyanate at a mass ratio of 1:0.5-1.5.

2. The two-component low-density PU structural adhesive according to claim 1, wherein the polyether carbonate polyol in Component A is 30-70 parts.

3. The two-component low-density PU structural adhesive according to claim 1, wherein the castor oil in Component A is 20-50 parts.

4. The two-component low-density PU structural adhesive according to claim 1, wherein the polyether carbonate polyol has a functionality of 2-4, a number-average molecular weight of 400-5000, and a mass percentage content of CO₂ of 5-35%; the castor oil is first-grade castor oil, and the modified castor oil is selected from at least one of A4100, A4110, or A4120; and the bisphenol A polyether polyol is selected from BPA3PO.

5. The two-component low-density PU structural adhesive according to claim 1, wherein the chain extender is selected from at least one of glycerol, diethylene glycol, dipropylene glycol or 1,5-pentanediol; the hollow glass beads are selected from at least one of HS28 or S28HS; the molecular sieve is selected from at least one of JLH-03-B or JZ-AZ3; and the fumed silica is selected from at least one of AEROSIL R202, TS-720 or KS-150.

6. The two-component low-density PU structural adhesive according to claim 1, wherein the silane coupling agent is selected from at least one of KH-560, KH-570 or CG-1146; the catalyst is selected from at least one of dibutyltin dilaurate, bismuth neodecanoate or triethylene diamine; and the dehydrating agent is selected from at least one of oxazolidine ALT-201 or Additive TI.

7. The two-component low-density PU structural adhesive according to claim 1, wherein NCO content of the isocyanate prepolymer is 10-20%; and the polyisocyanate is selected from at least one of liquefied MDI LL, MDI-50, M20S trimer, or PM-200.

8. A preparation method for the two-component low-density PU structural adhesive according to claim 1, comprising the following steps:
(1) preparation of Component A: at room temperature, adding 0-70 parts by weight of polyether carbonate polyol, 0-50 parts by weight of castor oil or/and modified castor oil, 0-30 parts by weight of bisphenol A polyether polyol, 5-20 parts by weight of a chain extender, 5-25 parts by weight of hollow glass beads, 1-10 parts by weight of molecular sieve, 1-5 parts by weight of fumed silica, 0.1-1 part by weight of a silane coupling agent and 0.01-0.15 part by weight of a catalyst into a container A, wherein the polyether carbonate polyol and the castor oil or/and the modified castor oil cannot be zero at the same time; and stirring the components evenly to obtain Component A;
(2) preparation of Component B: adding 40-75 parts by weight of isocyanate prepolymer, 5-parts by weight of the polyisocyanate, 5-25 parts by weight of hollow glass beads, 0.5-5 parts by weight of fumed silica and 0.1-1 part by weight of dehydrating agent into a container B and mixed evenly to obtain Component B; wherein the isocyanate prepolymer is prepared by reacting polyether carbonate polyol and polyisocyanate at a mass ratio of 1:0.5-1.5; and
(3) mixing Component A and Component B evenly at a volume ratio of 1:0.8-1.2 to obtain the two-component low-density PU structural adhesive.

9. The preparation method for the two-component low-density PU structural adhesive according to claim 8, wherein a preparation method for the isocyanate prepolymer is as follows: adding the polyether carbonate polyol into a reaction kettle, heating the same to 110-130° C. for vacuum dehydration for 1-2 h, cooling down to room temperature, adding the polyisocyanate and reacting at 70-90° C. for 2-3 h to obtain the isocyanate prepolymer, wherein a mass ratio of the polyether carbonate polyol to the polyisocyanate is 1:0.5-1.5.

10. An application of the two-component low-density PU structural adhesive according to claim 1 in structural bonding of a battery pack for a new energy vehicle.
